(19) United States
(12) Patent Application Publication
(10) Pub. No.: US 2002/0071890 A1
(43) Pub. Date: Jun. 13, 2002

(54) Volatile nut aroma and flavor compositions, and recovery thereof

(76) Inventors: Christopher E. Budwig, Columbus, OH (US); Maria Temperini, Marysville, OH (US); Dean Rushmore, Marysville, OH (US)

Correspondence Address: WINSTON & STRAWN, 200 PARK AVENUE, NEW YORK, NY, 10166-4193, US

(21) Appl. No.: 09/734,762

(22) Filed: Dec. 13, 2000

(51) Int. Cl. A23F 3/00

(52) U.S. Cl. 426/386; 426/473

(57) ABSTRACT

Natural nut flavor and aroma compositions and a process for preparing the compositions. The process involves feeding nuts to a grinding zone, grinding the nuts sufficiently to release a nut aroma and provide a nut aroma-containing gas, cooling the nut aroma-containing gas to condense a portion of the water present in the nut aroma-containing gas, removing the condensed water from the gas to produce an enriched nut aroma-containing gas, passing the enriched nut aroma-containing gas to at least one recovery zone, and recovering the aroma particles from the enriched nut aroma-containing gas to form a nut aroma and flavor composition. The nut aroma and flavor composition are suitable for incorporation in various food products where a nut flavor is desired and the invention further relates to foodstuffs prepared with the nut aroma/flavor compositions.

### FIELD OF THE INVENTION

This invention relates to natural nut aroma and flavor compositions useful in food products and the method for recovering the same from tree nuts and/or ground nuts. More particularly, the invention relates to the low temperature condensation and recovery of volatile aroma constituents from gases evolved during the processing of tree nuts and/or ground nuts.

### BACKGROUND OF THE INVENTION

Gases containing volatile aroma constituents are evolved during one or more stages of processing beverages such as coffee, tea, and cocoa. These volatile aroma gases may be recovered and used in a variety of food products. U.S. Pat. Nos. 5,030,473, 5,182,926, 5,222,364, and 5,323,623, each disclose methods of cryogenic recovery of aroma gases, and in particular, from coffee, tea, and cocoa.

There are also various methods known for collecting cocoa aroma gases. For example, documents DD 265,073 and 265,074 disclose a process for recovery of a cocoa butter aroma concentrate from the vapor from cocoa deodorization. The vapor is condensed by water or a cooled surface, and the aroma compounds are extracted with a lipid or lipid/solvent blend. The extract is then concentrated to yield a cocoa aroma concentrate.

Japanese Pat. Document No. 61,108,351 A reports a method for collecting mixtures of cocoa nibs and shell, roasting it at below 220° C. in a gas stream of steam, and condensing the vaporized flavor component at below 5° C.

U.S. Pat. No. 3,418,134 discloses a method of aromatizing food concentrates by using activated charcoal to recover volatiles during the preparation of concentrates from coffee, tea, or cocoa. The absorbed volatiles are then disclosed to be extracted by a solvent with very low boiling points.

The recovery of aroma gases has been applied mainly to cocoa, coffee, and tea. However, it is also desirable to isolate the aroma from nuts that have desired aroma and flavor characteristics and to have methods for recovering such aroma from nuts.

For example, U.S. Pat. No. 5,306,518 discloses a flavoring product including roasted and ground oilseeds of which the flavor and intensity is adjustable in a precise and easy manner. However, this patent does not disclose how to collect a suitable aroma from nuts.

Thus, it is desirable to provide a process for the collection and recovery of aroma gases evolved during the processing of nuts having desirable aroma and flavor properties. It is also desirable to obtain such aroma gases for use in a variety of foodstuffs to improve the flavor, aroma, and mouthfeel.

### SUMMARY OF THE INVENTION

The present invention relates to a simple but highly effective and efficient process of recovering aroma frost from gases evolved during processing of tree nuts and/or ground nuts. In particular, the process involves feeding the nuts to a grinding zone, grinding the nuts sufficiently to release a nut aroma and provide a nut-aroma containing gas, cooling the nut-aroma containing gas to condense a portion of the water present in the nut-aroma containing gas, removing the condensed water from the nut-aroma containing gas to produce an enriched aroma-containing gas, passing the enriched nut aroma-containing gas to at least one recovery zone, and recovering the nut aroma from the enriched nut aroma-containing gas to form a nut aroma and flavor composition.

In a preferred embodiment, the process includes feeding the nuts to the grinding zone at a rate from about 0.01 to about 10 pounds per minute and the grinding zone is maintained at a temperature from about 30° C. to about 100° C. In another preferred embodiment, the cooling to condense a portion of the water is at a temperature of less than about 10° C. The process may further include flushing the nut aroma-containing gas, with an inert gas, preferably nitrogen, to transport the nut aroma-containing gas. The process may further include recovering the nut aroma from the enriched nut-aroma containing gas by injecting liquid nitrogen into the enriched nut aroma-containing gas at a temperature sufficient to condense nut aroma frost particles from the nut aroma-containing gas and to volatilize the liquid nitrogen, to form a suspension of nut aroma frost particles in nitrogen gas; separating substantially all of the nut aroma frost particles from the gaseous suspension in the recovery zone on one or more filter elements; and recovering the nut aroma frost particles. The temperature to condense the nut aroma frost particles is less than about −80° C., preferably about −100° C. to about −160° C. The process may further include the step of back pulsing a gas into the one or more filter elements to dislodge the nut aroma frost particles from the filter.

In another embodiment, the aroma-containing gas is passed, either under a vacuum or pressure, through a recovery zone. In another embodiment, the nut aroma-containing gas is passed through a plurality of recovery zones in series and each succeeding zone is cooler than that of the preceding zone so as to fractionate the enriched nut aroma-containing gas.

The invention also relates to a nut aroma/flavor composition prepared by the process of feeding the nuts to a grinding zone, grinding the nuts sufficiently to release a nut aroma to release a nut-aroma containing gas, cooling the nut-aroma containing gas to condense a portion of the water present in the nut-aroma containing gas, removing the condensed water from the gas to produce an enriched aroma-containing gas, passing the enriched nut aroma-containing gas to at least one recovery zone, and recovering the enriched nut aroma-containing gas to form a nut aroma and flavor composition. The invention further relates to a foodstuff prepared by the nut aroma/flavor composition.

### BRIEF DESCRIPTION OF THE DRAWINGS

The invention may be better understood by reference to the attached drawings, which are in no way intended to limit the invention.

FIG. 1 is a schematic diagram of one embodiment of the entire aroma frost recovery system in accordance with the present invention; and

FIG. 2 is a vertical cross-sectional view of an aroma frost recovery unit in accordance with the present invention.

### DETAILED DESCRIPTION OF THE INVENTION

A suitable method of recovering nut aroma and flavor compositions, and using the same to improve the aroma, flavor, and mouthfeel of various foodstuffs has now been discovered. Thus, the present invention includes the recovery and use of nut aroma gases, which may be evolved during nut processing. More particularly, the nut aroma gases are recovered during conventional nut grinding and roasting processes.

The term “nut,” as used herein, includes tree and ground nuts and is defined as an indehiscent hard-shelled one-seeded fruit, a seed borne within a fruit having a hard shell, or the kernel or any other portion of any of these. The terms “nut aroma,” “aroma gas,” and “nut aroma gases” are used interchangeably herein. For example, suitable nuts include peanuts, hazelnuts, chestnuts, walnuts, almonds, macadamia nuts, cashews, pecans, Brazil nuts, pistachios, and filberts. Seeds that are not found in a hard shell but may also be used in the present invention include sunflower seeds, pine nuts, pumpkin seeds, and sesame seeds.

The terms “grinding,” “grind,” and “ground,” as used herein, means to crush, pulverize, or reduce to smaller fragments, especially by rubbing between two hard surfaces, and include, but are not limited to, crushing, pulverizing, chopping, and dicing.

The phrase “grinding zone,” as used herein, refers to a zone that includes the feeder and grinder.

The phrase “recovery zone,” as used herein, refers to a zone in which nut aroma gas is condensed to form aroma frost particles, which are then collected. The recovery zone may also be referred to as a cryogenic vessel or collector.

Some advantages of the present invention include, for example, improved aroma, flavor, and mouthfeel; increased recovery efficiency; the recovery of desirable volatile aroma and flavor compounds normally lost during the conventional processing of nuts; improved aroma and flavor of products to which the aroma gases are added; and the avoidance of artificial flavoring or aromas in foodstuffs containing compositions of the invention.

The method of recovering a nut aroma composition in the present invention includes: a) feeding a plurality of nuts to a grinding zone, b) grinding the nuts, optionally with heating, in a grinder or mill sufficient to release a nut aroma-containing gas, c) cooling the nut aroma-containing gas to condense a portion of the water that may be present in the nut aroma-containing gas, d) removing the condensed water from the gas to produce an enriched nut aroma-containing gas, e) passing the enriched nut aroma-containing gas to at least one recovery zone to form aroma frost particles, and f) recovering the aroma frost particles from the nut aroma-containing gas to form the nut aroma composition.

Typically, the tree nuts and/or ground nuts are fed continuously or in intervals into a grinder using a feeder. The feeder may be any other metering feeder, for example, an Acrisson feeder, at a rate from about 0.01 pounds to about 10 pounds per minute, preferably, from about 0.1 pounds to about 5 pounds per minute, and more preferably from about 0.5 pounds to about 3 pounds per minute.

Typically, the grinding of the nuts sufficient to release a nut aroma-containing gas may be done by any method known to those of ordinary skill in the art, including, but not limited to, the use of a grinder, a stone mill, an Urschell mill, a crusher/chopper, and the like. Any grinding device may be used that provides size reduction of the nuts without creating a paste. Preferably, the nuts are ground in an Urschell mill. The goal of grinding the nuts is to maximize the exposed surface area of the nuts and to release volatile aromas.

In another embodiment, the ground nuts are heated in the grinding zone to increase the amount of volatile components. Typically, the grinding zone is heated to a temperature from about 30° C. to about 100° C., preferably from about 30° C. to about 70° C., more preferably from about 30° C. to about 50° C.

Typically, the composition of the nut aroma gases evolved during conventional nut processing is largely carbon dioxide and water vapor (i.e., up to 90% or more by weight) together with the constituents of nut aroma. Although all conventional moisture-removing methods may be used, the amount of moisture in the aroma gas is preferably reduced by passing the evolved nut aroma gas through one condenser, or a plurality of condensers, where the condenser is cooled by circulating water and/or glycol to a temperature less than about 10° C., preferably from about −25° C. to about 7° C., more preferably between about −10° C. to about 5° C., to remove substantial quantities of water from the gas stream and minimize the presence of water in the final product. A stream of inert gas, such as nitrogen or carbon dioxide, may also be used to sweep the evolved aroma gas from the nuts and carry it through the aroma recovery operation. The aroma gas stream is normally maintained under a pressure sufficient to move the gas through the recovery operation, typically from about 0.1 psig to about 10 psig, preferably from about 0.5 psig to about 5 psig, taking into account the pressure drop across the filter units employed. Alternatively, the aroma gases may be pulled from the aroma generating equipment and moved through the aroma recovery operation by means of a vacuum. The use of a vacuum to move the aroma gases is preferred as it eliminates the need for a sweep gas, thereby increasing the concentration of the aromatic constituents in the gas stream and increasing the efficiency for condensing the aromatic constituents.

The nut aroma gas is carried or moved to a recovery zone whereby a cryogenic liquid or gas, such as liquid nitrogen, liquid helium, cold nitrogen gas, or other inert gases, is sprayed into the nut aroma gas stream to rapidly cool the gas to a temperature at which finely divided nut aroma frost particles are condensed, with the nut aroma frost particles being suspended in nitrogen gas produced by evaporation of the liquid nitrogen spray with which the nut aroma gas is contacted. Preferably, a valve is used to control the amount of cryogenic liquid or gas. The temperature of the cryogenic liquid or gas is typically less than about −80° C., preferably between about −100° C. and about −160° C., with the recovery zone being maintained at similar cryogenic temperature levels. Such temperatures facilitate rapid condensation of the aromatic constituents in the gas stream to form a suspension of nut aroma frost particles that is maintained well below the boiling point of the most volatile components and below the sublimation point of carbon dioxide, while ensuring that substantially all of the liquid nitrogen sprayed into the gas stream evaporates.

Preferably, the nut aroma gas and liquid nitrogen are introduced into the recovery zone in a manner which facilitates rapid, substantially uniform cooling of the gas while minimizing, preferably avoiding, contact between the cold aroma gas and the walls of the recovery zone. For example, the nut aroma gas stream may be introduced into the recovery zone by means of an inlet pipe which discharges the nut aroma gas into the center of the recovery zone. In one embodiment, a plurality of liquid nitrogen spray nozzles are mounted in the collector adjacent the discharge of the nut aroma gas inlet pipe, and are oriented so that their spray patterns converge at the midpoint of the nut aroma gas discharge and induct the nut aroma gas flow into the center portion of the collector. This advantageously directs the liquid nitrogen to inhibit the contact of the nut aroma frost particles and the walls of the recovery zone. In another embodiment, the liquid nitrogen spray nozzle is mounted coaxially within the gas inlet pipe adjacent the discharge end of the pipe whereby liquid nitrogen is sprayed into the nut aroma gas in the inlet pipe to produce a suspension of condensed nut aroma frost particles in an inert gas, such as nitrogen or carbon dioxide, which is carried into the recovery zone.

After the nut aroma frost is cooled and condensed, the suspension of inert gas and nut aroma frost particles is directed through one or more rigid porous filter media mounted in the recovery zone to separate substantially all of the finely divided nut aroma frost particles from the inert gas. Preferably, the porous filters include a plurality of porous cylindrical tubes, closed at the bottom and having an open upper end, with the gas phase of the suspension passing through the walls of the tubular filter from the outer or upstream surface to the inner or downstream surface of the filter and being discharged through the open upper end. Advantageously, a venturi nozzle is secured over the open upper end of each filter, with the inert gas being exhausted through each nozzle.

The porous cylindrical filter medium that may be used with the present invention preferably has a pore size distribution such that substantially all, i.e., greater than about 90%, preferably greater than about 95%, of the nut aroma frost particles are separated from the inert gas suspension passing through the filter, with the porous filter media preferably being thermally compatible with the cryogenic conditions maintained in the collector. In addition, the porous filters have sufficient structural strength and durability to withstand cyclic pressure increases during the reverse flow cleaning cycles discussed below. Filters made of porous ceramic or porous metal, such as porous stainless steel, sintered woven wire mesh, and the like, are suitable for use in the present invention. Exemplary cylindrical filters made of PSS® porous stainless steel, Grade H, sold by Pall Porous Metal Filters Corporation, Cortland, N.Y., which have an absolute rating of approximately five microns, have been found to be effective in separating at least 95% of the nut aroma frost particles from the gaseous suspension.

The size and number of filters mounted in the collector depends to a large extent on the flow rate of the nut aroma gas being processed by the cryogenic collector, and can be readily determined by routine experimentation. For example, a single porous stainless steel cylindrical filter 6.1 cm diameter and 50.8 cm in length, having about 960 cm² of filter area and an average pore size of 20 micrometers is effective in separating substantially all of the nut aroma frost particles from a nut aroma gas stream having a flow rate of about 200 standard cubic feet per hour (ft³/hr).

The gas phase of the suspension is forced through the pores of the porous cylindrical filter by maintaining a sufficient pressure differential across the walls of the filter, either by introducing the aroma gas into the collector under pressure or by maintaining the collector under slight vacuum, i.e., at a pressure less than atmospheric pressure. The gas phase passes through the porous filter walls to the interior of the cylindrical filter and exits from the recovery zone through the open upper end of the filter. This gas phase, which has a temperature of about −120° C. to about −160° C., is environmentally safe and may be vented into the atmosphere. Preferably, the gas phase is “recycled” into an insulated housing that surrounds the cryogenic collector. Recycling the inert gas exhaust stream in this manner facilitates maintaining the temperature of the cryogenic collector.

During filtration, nut aroma frost particles, which are separated from the inert gas suspension passed through the filter medium, tend to build up and form a filter cake on the outer walls of the cylindrical filter. The accumulating cake of nut aroma frost particles tends to inhibit further nut aroma frost particle flow and filtration. Therefore, the cake may be dislodged and removed from the filter by periodically directing a back pulse of inert gas, preferably nitrogen gas, into the open upper end of the cylindrical filter, at a pressure appreciably greater than on the outer wall of the filter. The pulses are typically from about 0.1 second to about 1 second duration repeated at a time interval in the range of about 0.5 minute to about 3 minutes during normal operation of the aroma recovery. Typically, nitrogen gas at a pressure of about 90 psig is used, although other suitable pressures can be readily determined depending upon the specific filter design.

The nut aroma frost particles dislodged from the cakes in the filters fall into a collector at the bottom of the recovery zone and are removed either periodically or on a continuous basis. For example, conventional means, such as a rotary valve, a screw conveyor, an endless belt, and the like, may be provided at the bottom of the recovery zone for the removal of the dislodged nut aroma frost particles from the recovery zone on a continuous basis. Alternatively, an insulated collector may be removably secured to the bottom of the recovery zone below the filters, with the dislodged nut aroma frost particles falling into the collector for periodic recovery of the nut aroma frost particles. In one embodiment the nut aroma frost particles are collected and mixed into a carrier, for example, with a ribbon blender or other suitable mixing device.

The recovered nut aroma frost particles is typically combined with a carrier after it is recovered. Suitable carriers include, but are not limited to, vegetable oils, tropical oils, medium chain triglycerides, propylene glycol, glycerol, cocoa butter, water, and other acceptable food grade solvents. The compositions advantageously contain most or all of the same volatile components present in the original nut itself. The recovered nut aroma frost particles provide a unique and improved natural nut aroma and flavor composition suitable for addition to various food products. The nut aroma frost recovery system may be similar in design to the apparatus disclosed in U.S. Pat. Nos. 5,182,926, 5,222,364, and 5,323,623, for example.

Some suitable applications for the nut aroma frost particles are beverages (e.g., coffee or creamers), culinary food products (e.g., cookie dough or cake mixes), confectionery food products (e.g., chocolate compounds and coatings), ice cream, and ice cream coatings. The nut aroma and flavor compositions, once recovered according to the invention, can be added to foodstuffs by any method available to one of ordinary skill in the art.

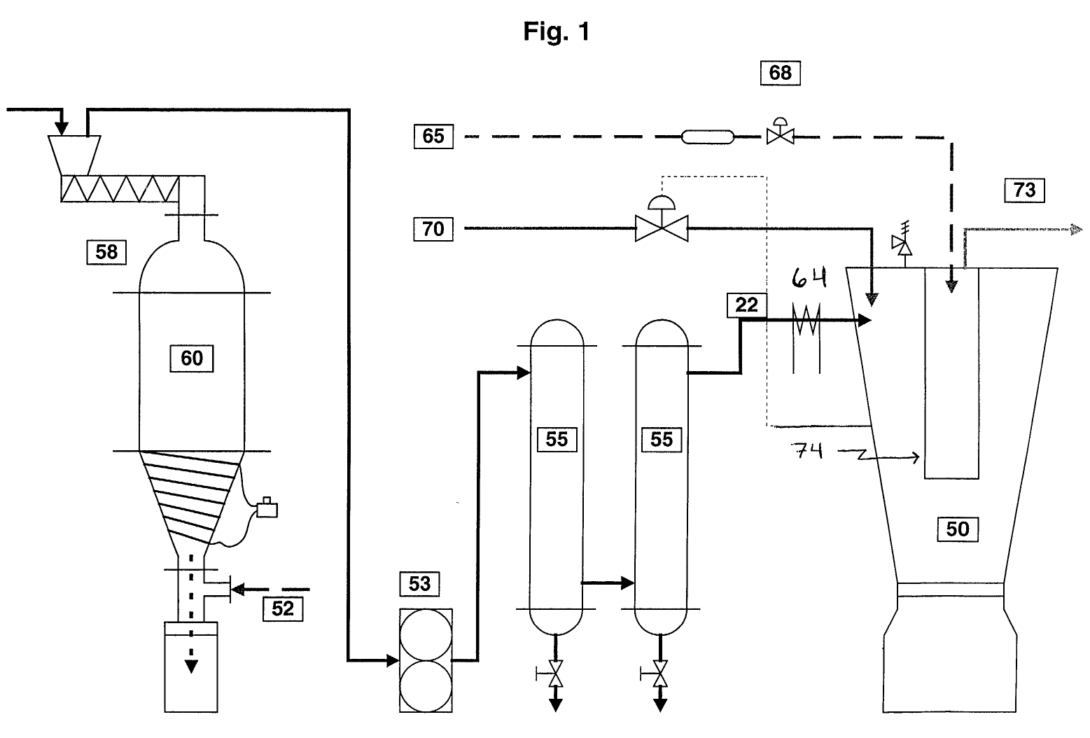

FIG. 1 is a schematic diagram of the nut aroma frost recovery system. The roasted nuts are continuously fed at a rate of from about 0.01 pound per minute to about 10 pounds per minute, preferably from about 0.1 pound per minute to about 5 pounds per minute, more preferably from about 0.5 pound per minute to about 3 pounds per minute to a mill 60, such as a Urshell mill by a feeder 58, such as an Accrison feeder. The mill 60 is maintained at a temperature from about 30° C. to about 100° C., preferably from about 30° C. to about 70° C., more preferably from about 30° C. to about 50° C. The feeder/grinder system 58, 60 is flushed with inert gas, such as nitrogen or carbon dioxide, from a supply tank 52 at between about 75 ft³/hr to about 150 ft³/hr, preferably about 90 ft³/hr to about 110 ft³/hr, which carries the nut aroma gas from the feeder/grinder system 58, 60 through a roots blower 53 and into one or more condensers 55. The one or more condensers 55 are cooled to below about 10° C., preferably from about −25° C. to about 7° C., and more preferably from about −10° C. to about 5° C., by chilled water and/or an alcohol, such as glycol. The nut aroma gas stream is then directed into an aroma frost recovery zone 50 by first passing through an inlet tube 22, that may be heated by a heater 64. Liquid nitrogen from a supply tank 70 is directed into the aroma frost recovery zone 50, also known as the cryogenic vessel or chamber. The aroma frost recovery zone 50 recovers the nut aroma frost for use in the compositions of the invention by passing, via back pulsing, inert gas 65 through a time actuated valve 68 into the filter 74. The exhaust from the process is vented through a vent line 73 connected to the recovery zone 50.

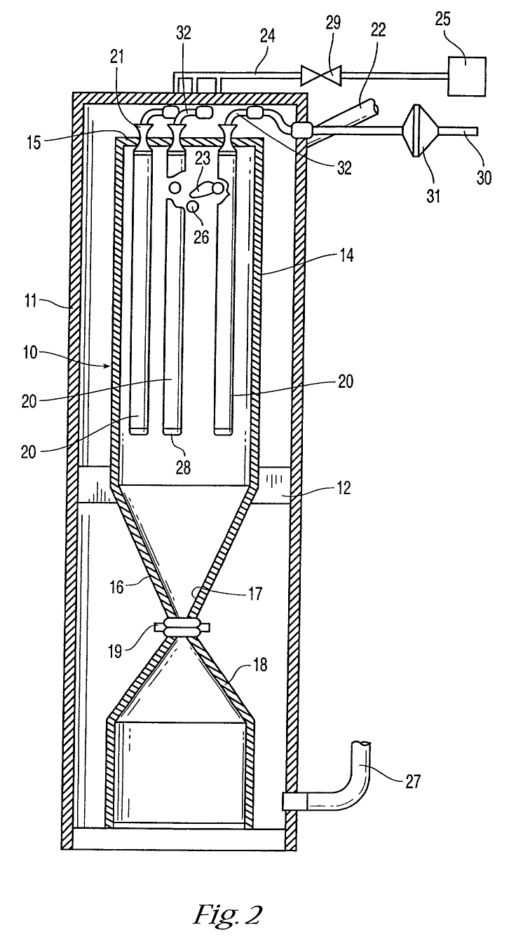

FIG. 2 shows a vertical cross section view of a portion of the aroma frost recovery zone 10, of the present invention, which includes a recovery zone 10 mounted centrally within an insulated cylindrical housing 11 by means of support brackets 12. recovery zone 10 comprises a cylindrical shell 14 closed at the top by wall 15 and having a funnel-shaped bottom section 16 with an orifice 17 through which condensed nut aroma frost particles may be removed. Insulated container 18 is removably secured to bottom section 16 by suitable clamping means 19, such as a tri-clamp fitting. Container 18 is adapted to be removed periodically through a door (not shown) in the base of housing 11.

Tubular porous filters 20, of suitable cryogenic filtering material, for example porous stainless steel, are mounted within recovery zone 10 adjacent the top wall 15 thereof. Filters 20 are closed at the bottom end, such as by welded end cap 28 and have an open upper end, with a venturi nozzle 21 being secured over the open upper end of each tubular filter 20. Each of the venturi nozzles 21 extends through a suitable opening in top wall 15 of recovery zone 10 to exhaust gas from the interior of a tubular filter 20 out of recovery zone 10 into cylindrical housing 11 from which the gas is discharged through exhaust line 27. Inlet tube 22, which carries aroma gas evolved during nut processing, communicates with the interior of recovery zone 10 through opening 23 in the upper portion of shell 14. Inlet tube 22 is disposed normal to the sidewall of shell 14 at a slight downward angle so as to direct the flow of aroma gas discharged from tube 22 toward the vertical midline of shell 14, away from the sidewalls. Liquid nitrogen from supply tank 25 is carried in line 24 into recovery zone 10 with the liquid nitrogen being sprayed from nozzles 26 mounted in recovery zone 10 adjacent the discharge end of inlet tube 22. Spray nozzles 26 are oriented so that their spray patterns are directed away from the sidewalls of shell 14, toward the center of the aroma gas stream discharged through opening 23. A suitable valve 29 is provided in line 24 to control the temperature within the recovery zone 10 by increasing or decreasing the flow of liquid nitrogen to spray nozzles 26.

Pressurized inert gas is carried in line 30 to pulsing tank 31, optionally with a periodic back pulse of inert gas, such as nitrogen gas, being introduced into the interior of tubular filters 20 through pulse lines 32 which extend, coaxially into each of the venturi nozzles 21 mounted on tubular filters 20. Any of the pulse generating means commonly used to generate pulses of pressurized back flushing gas may be used in the present invention for cleaning the filters 20.

In operation, nut aroma gas of primarily carbon dioxide and water vapor together with nut aroma constituents is carried in tube 22. The nut aroma gas, which typically is under a pressure of from about 0.1 psig to about 10 psig, preferably from about 0.5 to about 5 psig, is discharged into cylindrical shell 14 in a downwardly direction toward the center of the shell and away from the sidewalls thereof. Liquid nitrogen is sprayed into the aroma gas stream through nozzles 26 mounted within casing 14 equidistant around the discharge of tube 22 with the liquid nitrogen spray being directed toward the center of the recovery zone so that the aroma gas stream discharged from tube 22 is rapidly and uniformly cooled to condense the aroma gas as finely divided nut aroma frost particles suspended in a stream of inert gas, while avoiding or minimizing contact of the cooled aroma gas stream with the sidewalls of shell 14. The supply of liquid nitrogen to nozzles 26 is adjusted to maintain the temperature in recovery zone 10 below about −80° C., preferably from about −100° C. to about −160° C., to maintain the nut aroma frost particles at a temperature below the boiling point of their most volatile constituents while ensuring that substantially all of the liquid nitrogen is volatilized. Three rigid tubular porous metal filters 20 are mounted in recovery zone 10 adjacent its top wall, with each of the filters having a venturi nozzle 21 attached to the upper end of the filter. Each of the nozzles 21 extends through the top wall of the recovery zone 10. The filters are preferably made of porous stainless steel having a pore size from about 2 microns to about 10 microns, preferably from about 4 microns to about 8 microns, more preferably about 5 microns with the tubular filters preferably having a length of about 50 cm and a diameter of about 6 cm. The inert gas phase of the suspension is forced through the pores of the filter tubes by maintaining a pressure differential of about 15 mmHg to about 40 mmHg across the walls of the filters, while the nut aroma frost particles are deposited on the outer surface of the filters. The inert gas, which is still at the temperature described herein, passes through the porous filter walls to the interior of the filters, through the venturi nozzle at the top of each filter, and is vented from recovery zone 10 into the interior of insulated housing 11 surrounding shell 14, from where it is exhausted to the atmosphere through exhaust line 27. In this manner, the temperature within the housing may be maintained at about −120° C. or below. The tubular filters are back-pulsed about every 60 seconds for a period of about 0.3 second with inert gas at a pressure of about from about 50 psig to about 150 psig, preferably from about 65 psig to about 120 psig, more preferably from about 80 psig to 100 psig, to dislodge the nut aroma frost particles which collect on the exterior of the filters, with the nut aroma frost particles being collected in a container. The recovered nut aroma frost particles are periodically removed from the container for incorporation into food products to increase the nut aroma, flavor, and mouthfeel thereof.

In an alternative mode of operation, the recovery of aroma gas can be carried out in a manner to effect fractionation of the aromatic constituents of the gas. That is, the aroma-bearing gas stream can be passed through a number of recovery zones in series, with each succeeding recovery zone being operated at a lower temperature than the one preceding it. In this manner, a series of aromatic constituents having successively lower freezing points are condensed out of the aroma gas stream and recovered. Each of the series of recovery zone is provided with temperature control means to maintain the temperature in each recovery zone within a predetermined range. Suitable temperature control means include, for example, a temperature controller associated with each recovery zone for determining the temperature within the recovery zone and comparing it to a set point temperature. The temperature controller is associated with and controls a valve for the liquid nitrogen supply tank to the recovery zone. If the temperature of the recovery zone is below the preset level, the value is opened further to allow more inert gas to escape. This escape of gas reduces the pressure within the liquid nitrogen supply tank, thus reducing the pressure drop across the spray nozzle in the recovery zone. By reducing the pressure drop across the nozzle, the flow of liquid nitrogen from the supply tank to the recovery zone is reduced and the temperature within the recovery zone rises. Similarly, if the temperature in the recovery zone is too high, the valve is closed, which increases the flow of liquid nitrogen to the spray nozzle, thereby reducing the temperature in the recovery zone.

This accurate control of temperature within each recovery zone enables a number of recovery zones to be connected in series and operated at successively lower temperatures, thereby effecting fractionation of the aromatic constituents of the aroma gas.

### EXAMPLES

The invention may be further defined by reference to the following examples describing in detail the preparation of the compounds and the compositions used in the methods of the present invention, as well as their utility. The examples are representative and should not be construed to limit the scope of the invention.

### Example 1

The use of Peanut Aroma Frost in Compound Coating

One part peanut aroma frost prepared according to the invention was mixed with 10 parts of lauric fat blend to make an “aromatized fat.” Separately, a refined mix of skim milk powder, sugar, cocoa powder, and the same lauric fat blend was prepared as a nut-flavored chocolate substitute. 1.7 grams of the aromatized fat was then added to a 300 gram batch of the refined mix. Two additional batches were also prepared with 1.0 gram and with 3.0 grams of aromatized fat per 300 grams of the refined mix. The nut-flavored chocolate substitute was evaluated for taste and found to have desirable nut flavor and aroma.

### Example 2

The use of Almond Aroma Frost in Compound Coating

One part almond aroma frost can be prepared according to the invention and mixed with 10 parts of lauric fat blend to make an “aromatized fat.” Separately, a refined mix of skim milk powder, sugar, cocoa powder, and the same lauric fat blend can be prepared as a nut-flavored chocolate substitute. From about 1 to 3 grams of the aromatized fat can be added to a 300 gram batch of the refined mix to provide a nut-flavored chocolate substitute.

### Example 3

Use of Almond Aroma Frost in Ice Cream Coating

Vegetable (hydrogenated soybean) oil can be used as a carrier at a 1:10 ratio with an almond aroma frost prepared as described in Example 2 to provide an aromatized oil, which can be added to a standard spray chocolate coating in an amount of between about 0.5 and 1% by weight of the spray chocolate.

These examples illustrate the successful uses of nut aroma frost in various foods and beverages. It is to be recognized and understood that the invention is not to be limited to the exact configuration as illustrated and described herein. For example, it should be apparent that a variety of suitable modifications may be made from the disclosure of the Detailed Description of the Invention. Accordingly, all expedient modifications readily attainable by one of ordinary skill in the art from the disclosure set forth herein are deemed to be within the spirit and scope of the present claims.

What is claimed is:

1. A process of recovering a nut aroma and flavor composition from a plurality of nuts which comprises:
feeding the nuts to a grinding zone;
grinding the nuts sufficiently to release a nut aroma and provide a nut aroma-containing gas;
cooling the nut aroma-containing gas to condense a portion of the water present in the nut aroma-containing gas;
removing the condensed water from the gas to produce an enriched nut aroma-containing gas;
passing the enriched nut aroma-containing gas to at least one recovery zone; and
recovering the nut aroma from the enriched nut aroma-containing gas to form a nut aroma and flavor composition.

2. The process of claim 1, wherein the nuts are fed to the grinding zone at a rate from about 0.01 pounds to about 10 pounds per minute.

3. The process of claim 1, wherein the grinding zone is maintained at a temperature from about 30° C. to about 100° C.

4. The process of claim 1, wherein the nut-aroma containing gas is cooled to a temperature of less than about 10° C. to condense the water.

5. The process of claim 1, further comprising flushing the nut aroma-containing gas with an inert gas in an amount sufficient to transport the nut aroma-containing gas.

6. The process of claim 5, wherein the inert gas is nitrogen gas.

7. The process of claim 1, wherein recovering the nut aroma from the enriched nut-aroma containing gas comprises:
injecting liquid nitrogen into the enriched nut aroma-containing gas at a temperature sufficient to condense nut aroma frost particles from the nut aroma-containing gas and to volatilize the liquid nitrogen, to form a suspension of nut aroma frost particles in nitrogen gas;
separating substantially all of the nut aroma frost particles from the gaseous suspension in the recovery zone on one or more filter elements; and
recovering the frost particles.

8. The process of claim 7 wherein the temperature to condense the nut aroma frost particles is less than about −80° C.

9. The process of claim 8, wherein the temperature is from about −100° C. to about −160° C.

10. The process of claim 9, wherein the separating substantially all of the nut aroma frost particles from the gaseous suspension further comprises back pulsing a gas into the one or more filter elements to dislodge the aroma particles from the filter.

11. The process of claim 1, wherein the nut-containing aroma gas is passed to the recovery zone under pressure or vacuum.

12. The process of claim 1, wherein the recovering comprises passing the nut aroma-containing gas through a plurality of recovery zones in series and wherein each succeeding zone is cooler than that of the preceding zone so as to fractionate the enriched nut aroma-containing gas.

13. A nut aroma/flavor composition prepared by a process comprising:
feeding the nuts into a grinding zone;
grinding the nuts sufficiently to release a nut aroma and form a nut aroma-containing gas;
cooling the nut aroma-containing gas to condense a portion of the water present in the nut aroma-containing gas;
removing the condensed water from the gas to produce an enriched nut aroma-containing gas;
passing the enriched nut aroma-containing gas to at least one recovery zone; and
recovering the aroma particles from the enriched nut aroma-containing gas to form a nut aroma composition.

14. A foodstuff which contains a flavor effective amount of the nut aroma/flavor composition of claim 13 therein.
